(19) United States
(12) Patent Application Publication
(10) Pub. No.: US 2019/0063328 A1
(43) Pub. Date: Feb. 28, 2019

(54) GAS TURBOMACHINE FUEL SYSTEM, CONTROL SYSTEM AND RELATED GAS TURBOMACHINE

(71) Applicant: General Electric Company, Schenectady, NY (US)

(72) Inventor: David Scott Keeney, Dubai (AE)

(21) Appl. No.: 15/688,963

(22) Filed: Aug. 29, 2017

(51) Int. Cl. F02C 7/232; F02C 9/26; F23R 3/28; F23R 3/34; F23R 3/46; F02C 3/04

(52) U.S. Cl. CPC F02C 7/232; F02C 9/263; F02C 3/04; F23R 3/34; F23R 3/46; F23R 3/283

(57) ABSTRACT

Various embodiments include gas turbomachine (GT) fuel systems, related control systems and GTs. In some cases, the GT fuel system includes: a plurality of combustion chambers circumferentially disposed around a gas turbine; a set of fuel nozzles directly mounted to each of the plurality of combustion chambers; a set of conduits coupled with each of the set of fuel nozzles at a first end of each of the conduits; and a set of liquid fuel check valves coupled with a second end of each of the set of conduits, the set of liquid fuel check valves being positioned radially offset and axially offset from the set of fuel nozzles.

### FIELD OF THE INVENTION

The subject matter disclosed herein relates to gas turbomachines (or, turbomachines). More particularly, the subject matter disclosed herein relates to gas turbomachine fuel systems and related control approaches.

### BACKGROUND OF THE INVENTION

Many conventional gas turbomachine (GT) engines (or simply, GTs) run using a dual-fuel approach, meaning these systems utilize a primary fuel type (e.g., gas fuel) and maintain a secondary, or backup fuel type (e.g., liquid fuel) in case of failure or maintenance in the primary fuel system. These dual-fuel GTs conventionally run on the primary fuel nearly all of the time, e.g., 95+ percent of the time. However, the secondary fuel system needs to be tested periodically in order to ensure its functional reliability. In practice, these secondary fuel tests are often performed infrequently. This results in stagnate standby liquid fuel overheating in the liquid fuel supply tubing that is located in the high heat zone areas of the GT. The liquid fuel in the tubing is heated above its change of state point resulting in fuel solidification/carbonization (coking) during regular GT operation on primary gas fuel. Coking, as is known in the art, is caused by high temperature stress and the presence of instability precursors in the fuel that can form color bodies and sediments. Trace amounts of transition metals, like copper and iron, catalyze the sediment forming reactions. These sediments form into coking deposits that build up internally on fuel system components, when back-up fuel operations are initiated the normal fuel flow will push the solid coke particles that formed in the hot tubing into the check valves and fuel nozzles, resulting in contamination fouling and restricted fuel flows. These contamination deposits lead to inefficient and erratic engine performance due to creating obstructions to the fuel flow and poor atomization that is needed to properly fire all the GT fuel nozzles at the same pressures and flows simultaneously. Uneven fuel flows due to contamination clogging of the fuel nozzle outlet ports result in redirected flame patterns inside the combustion chambers that can cause over heated metal damage to GT internal parts, the failure mode process is similar to that of a welders cutting torch. This can lead to costly combustion hardware distress, engine shutdowns and/or maintenance.

### BRIEF DESCRIPTION OF THE INVENTION

Various embodiments include gas turbomachine (GT) fuel systems, related control systems and GTs. In a first aspect, a GT fuel system includes: a plurality of combustion chambers circumferentially disposed around the GT; a set of fuel nozzles directly mounted to each of the plurality of combustion chambers; a set of fuel feeder tubing conduits coupled with each of the of fuel nozzles at a first end of each of the conduits; and a set of liquid fuel check valves coupled with a second end of each of the set of conduits, the set of liquid fuel check valves being positioned radially offset and axially offset from the set of fuel nozzles.

A second aspect of the disclosure includes a system having: at least one computing device configured to control a fuel system in a gas turbomachine (GT), the fuel system including: a plurality of combustion chambers circumferentially disposed around the GT; a set of fuel nozzles directly mounted to each of the plurality of combustion chambers for introducing a fuel into each of the plurality of combustion chambers; and a set of check valves fluidly coupled with the set of fuel nozzles and radially and axially offset from the set of fuel nozzles, the fuel including a primary fuel and a secondary fuel, the at least one computing device configured to: purge the set of fuel nozzles of the primary fuel in response to receiving operating parameter data indicating a secondary fuel test is due; purge the set of fuel nozzles of the primary fuel; introduce the secondary fuel to the set of nozzles after purging of the primary fuel; purge the set of fuel nozzles of the secondary fuel after introducing the secondary fuel to the set of nozzles; and introduce the primary fuel to the set of fuel nozzles after purging the secondary fuel.

A third aspect of the disclosure includes a gas turbomachine (GT) having: a compressor section; a combustor section coupled with the compressor section, the combustor section including: a plurality of combustion chambers; a set of fuel nozzles directly coupled with each of the plurality of combustion chambers; a set of conduits coupled with each of the set of fuel nozzles at a first end of each of the conduits; and a set of liquid fuel check valves coupled with a second end of each of the set of conduits, the set of liquid fuel check valves being radially offset and axially offset from the set of fuel nozzles; and a turbomachine section coupled with the combustor section.

### BRIEF DESCRIPTION OF THE DRAWINGS

These and other features of this disclosure will be more readily understood from the following detailed description of the various aspects of the invention taken in conjunction with the accompanying drawings that depict various embodiments of the invention, in which:

FIG. 1 shows a schematic illustration of a gas turbomachine engine (GT), including a control system, according to various embodiments of the disclosure.

FIG. 2 shows a schematic view of a control architecture that may be used with the control system of FIG. 1 to control operation of the GT, according to various embodiments of the disclosure.

FIG. 3 shows a schematic perspective view of a fuel system according to various embodiments of the disclosure.

FIG. 4 shows a schematic end view of the fuel system of FIG. 3.

FIG. 5 shows a schematic side view of the fuel system of FIGS. 3 and 4.

FIG. 6 shows a flow diagram illustrating a process for controlling a fuel system according to various embodiments of the disclosure.

FIG. 7 shows an illustrative environment including a control system according to various embodiments of the invention.

It is noted that the drawings of the various aspects of the disclosure are not necessarily to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, subject matter disclosed herein relates to gas turbomachines. More particularly, the subject matter disclosed herein relates to gas turbomachine fuel systems along with control of such systems.

In the following description, reference is made to the accompanying drawings that form a part thereof, and in which is shown by way of illustration specific example embodiments in which the present teachings may be practiced. These embodiments are described in sufficient detail to enable those skilled in the art to practice the present teachings and it is to be understood that other embodiments may be utilized and that changes may be made without departing from the scope of the present teachings. The following description is, therefore, merely illustrative.

As used herein, the terms “axial” and/or “axially” refer to the relative position/direction of objects along axis A, which is substantially parallel with the axis of rotation of the turbomachine (in particular, the rotor section). As further used herein, the terms “radial” and/or “radially” refer to the relative position/direction of objects along axis (r), which is substantially perpendicular with axis A and intersects axis A at only one location. Additionally, the terms “circumferential” and/or “circumferentially” refer to the relative position/direction of objects along a circumference which surrounds axis A but does not intersect the axis A at any location.

As noted herein, secondary fuel tests in dual-fuel gas turbomachines (GTs, also referred to as gas turbines in the art) are often performed infrequently, which causes the liquid fuel present in fuel nozzle supply tubing within the GT's hot zone to form hard particles of coke contaminates. The conventional fuel systems including supply tubing and check valves for controlling fuel flow are directly mounted to the fuel nozzles (e.g., such that they are joined with only a negligible separation of about 7-8 centimeters (or about 3 inches)). This configuration places the stagnate fuel in an area where the ambient temperatures that are generated from normal GT operations overheat the fuel.

In contrast to conventional systems, various aspects of the disclosure include a fuel system for a dual-fuel GT with a fuel containing supply tube and check valve configuration that is separated from the GT's heat zone in order to naturally mitigate liquid fuel coking within the supply tubing. In this configuration, the tubing spanning between the check valves and the fuel nozzles in the high heat areas will contain purge air instead of stagnate fuel. In particular cases, the fuel system includes a set of supply tubing and check valves which are separated from the fuel nozzles by an off-set distance (e.g., approximately one (1) meter), in order to provide sufficient separation of those tubing and valves from the high heat zone of the GT to mitigate coking. The high heat zone locations can be identified and mapped by performing a thermal study of the GT and its installed compartment. In various aspects, the fuel system includes tubing and check valves, connected to the fuel nozzles radially disposed around the GT, separated by an off-set distance to place them in the cooler areas that are identified during the thermal study. Conventional fuel systems, which directly pair the feeder tubing and check valves to the fuel nozzle (and in the presence of the natural high heat of a GT), do not provide this thermal separation of the supply tubing and check valves that contain the stagnate backup fuel to cool areas of the GT compartment. This relocation of the tubing and check valves away from the natural heat of the GT is beneficial to reducing and eliminating coking within these components.

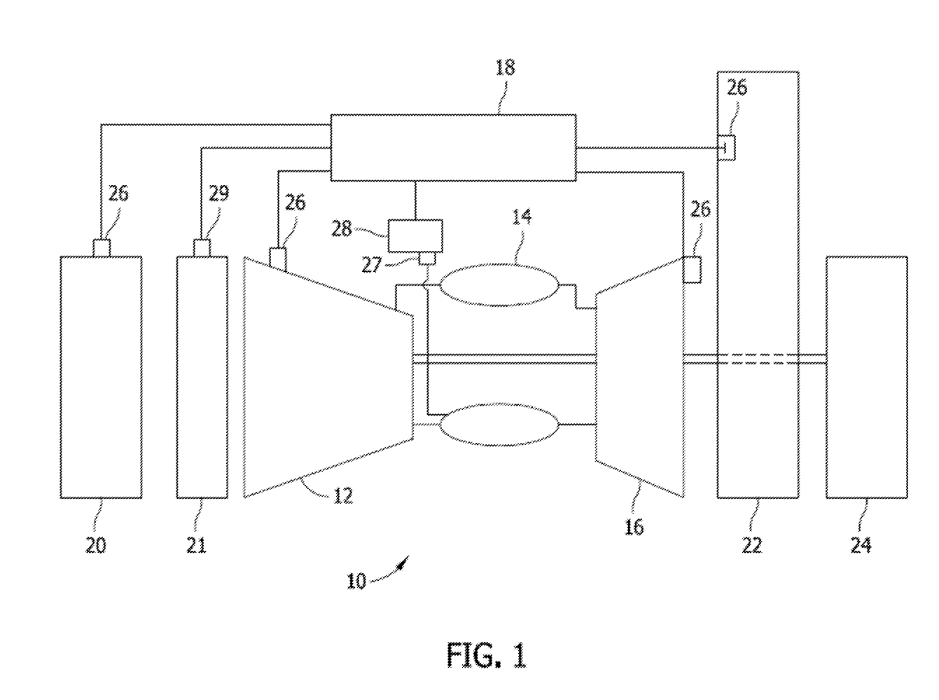

FIG. 1 shows a schematic illustration of a gas turbomachine engine (GT) 10 including a computer control system (or simply, controller) 18, according to various embodiments. In various embodiments, gas turbomachine engine 10 includes a compressor 12, a combustor 14, a turbomachine 16 drivingly coupled to compressor 12, and a computer control system, or control system 18. An inlet duct 20 to compressor 12 channels ambient air and, in some instances, injected water to compressor 12. Duct 20 may include ducts, filters, screens, or sound absorbing devices that contribute to a pressure loss of ambient air flowing through inlet duct 20 and into inlet guide vanes (IGV) 21 of compressor 12. Combustion gasses from gas turbomachine engine 10 are directed through exhaust duct 22. Exhaust duct 22 may include sound adsorbing materials and emission control devices that induce a backpressure to gas turbomachine engine 10. An amount of inlet pressure losses and backpressure may vary over time due to the addition of components to inlet duct 20 and exhaust duct 22, and/or as a result of dust or dirt clogging inlet duct 20 and exhaust duct 22, respectively. In various embodiments, gas turbomachine engine 10 drives a generator 24 that produces electrical power.

In various embodiments, a plurality of control sensors 26 detect various operating conditions of gas turbomachine engine 10, generator 24, and/or the ambient environment during operation of gas turbomachine engine 10. In many instances, multiple redundant control sensors 26 may measure the same operating condition. For example, groups of redundant temperature control sensors 26 may monitor ambient temperature, compressor discharge temperature, turbomachine exhaust gas temperature, and/or other operating temperatures the gas stream (not shown) through gas turbomachine engine 10. Similarly, groups of other redundant pressure control sensors 26 may monitor ambient pressure, static and dynamic pressure levels at compressor 12, turbomachine 16 exhaust, and/or other parameters in gas turbomachine engine 10. Control sensors 26 may include, without limitation, flow sensors, pressure sensors, speed sensors, flame detector sensors, valve position sensors, guide vane angle sensors, and/or any other device that may be used to sense various operating parameters during operation of gas turbomachine engine 10.

As used herein, the term “operating parameter” refers to characteristics that can be used to define the operating conditions of gas turbomachine engine 10, such as temperatures, pressures, and/or gas flows at defined locations within gas turbomachine engine 10. Some parameters are measured, i.e., are sensed and are directly known, while other parameters are calculated by a model and are thus estimated and indirectly known. Some parameters may be initially input by a user to control system 18. The measured, estimated, or user input parameters represent a given operating state of gas turbomachine engine 10.

A fuel control system 28 regulates an amount of fuel flow from a fuel supply (not shown) to combustor 14, an amount split between primary and secondary fuel nozzles (not shown), and an amount mixed with secondary air flowing into combustor 14. Fuel control system 28 may also select a type of fuel for use in combustor 14. Fuel control system 28 may be a separate unit or may be a component of control system 18.

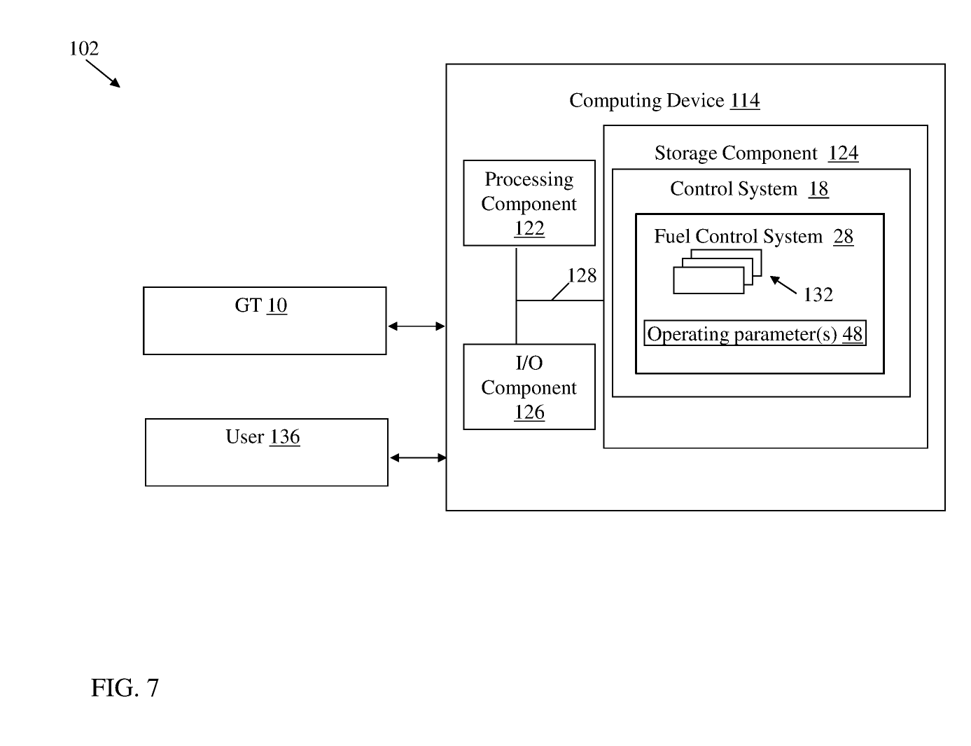

Control system 18 may be a computer system (computing device 114, FIG. 7) that includes at least one processor (processing component 122, FIG. 7) and at least one memory device (storage component 124, FIG. 7) that executes operations to control the operation of gas turbomachine engine 10 based at least partially on control sensor 26 inputs and on instructions from human operators. The control system 18 may include, for example, a model of gas turbomachine engine 10. Operations executed by control system 18 may include sensing or modeling operating parameters, modeling operational boundaries, applying operational boundary models, or applying scheduling algorithms that control operation of gas turbomachine engine 10, such as by regulating a fuel flow to combustor 14. Control system 18 compares operating parameters of gas turbomachine engine 10 to operational boundary models, or scheduling algorithms used by gas turbomachine engine 10 to generate control outputs, such as, without limitation, a firing temperature. Commands generated by control system 18 may cause a fuel actuator 27 on gas turbomachine engine 10 to selectively regulate fuel flow, fuel splits, and/or a type of fuel channeled between the fuel supply and combustors 14. Other commands may be generated to cause actuators 29 to adjust a relative position of IGVs 21, adjust inlet bleed heat, or activate other control settings on gas turbomachine engine 10.

As noted herein, operating parameters generally indicate the operating conditions of gas turbomachine engine 10, such as temperatures, pressures, and gas flows, at defined locations in gas turbomachine engine 10 and at given operating states. Some operating parameters are measured, i.e., sensed and are directly known, while other operating parameters are estimated by a model and are indirectly known. Operating parameters that are estimated or modeled, may also be referred to as estimated operating parameters, and may include for example, without limitation, firing temperature and/or exhaust temperature. Operational boundary models may be defined by one or more physical boundaries of gas turbomachine engine 10, and thus may be representative of optimal conditions of gas turbomachine engine 10 at each boundary. Further, operational boundary models may be independent of any other boundaries or operating conditions. Scheduling algorithms may be used to determine settings for the turbomachine control actuators 27, 29 to cause gas turbomachine engine 10 to operate within predetermined limits. Typically, scheduling algorithms protect against worst-case scenarios and have built-in assumptions based on certain operating states. Boundary control is a process by which a controller, such as control system 18, is able to adjust turbomachine control actuators 27, 29 to cause gas turbomachine engine 10 to operate at a preferred state.

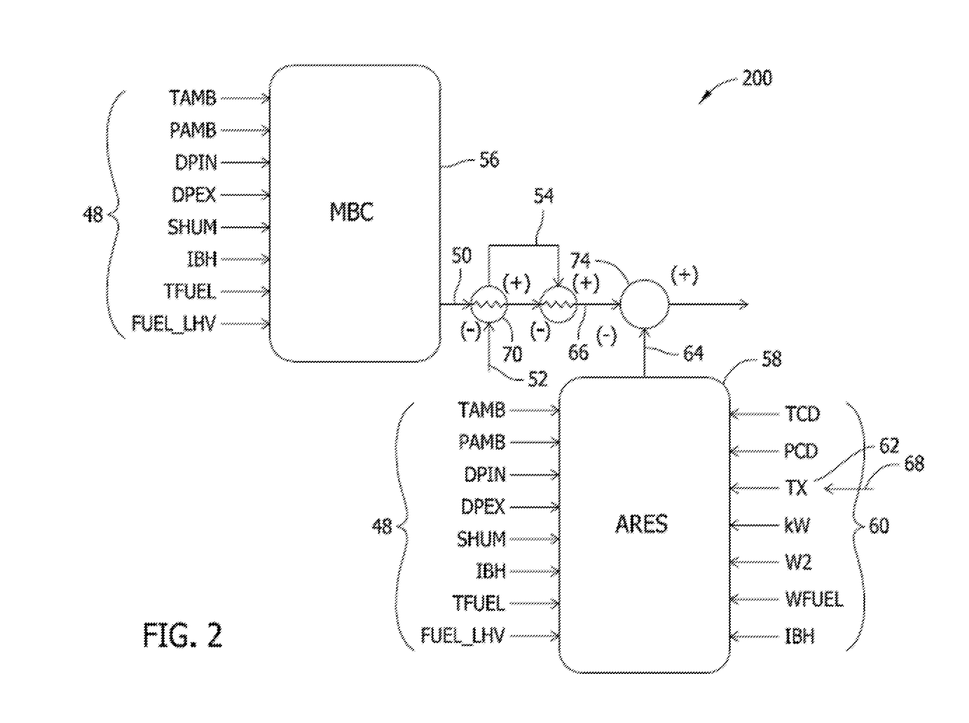

FIG. 2 shows a schematic view of an example control architecture 200 that may be used with control system 18 (shown in FIG. 1) to control operation of gas turbomachine engine 10 (shown in FIG. 1). More specifically, in various embodiments, control architecture 200 is implemented in control system 18 and includes a model-based control (MBC) module 56. MBC module 56 is a robust, high fidelity, physics-based model of gas turbomachine engine 10. MBC module 56 receives measured conditions as input operating parameters 48. Such parameters 48 may include, without limitation, ambient pressure and temperature, fuel flows and temperature, inlet bleed heat, and/or generator power losses. MBC module 56 applies input operating parameters 48 to the gas turbomachine model to determine a nominal firing temperature 50 (or nominal operating state 428). MBC module 56 may be implemented in any platform that enables operation of control architecture 200 and gas turbomachine engine 10 as described herein.

Further, in various embodiments, control architecture 200 includes an adaptive real-time engine simulation (ARES) module 58 that estimates certain operating parameters of gas turbomachine engine 10. For example, in one embodiment, ARES module 58 estimates operational parameters that are not directly sensed such as those generated by control sensors 26 for use in control algorithms ARES module 58 also estimates operational parameters that are measured such that the estimated and measured conditions can be compared. The comparison is used to automatically tune ARES module 58 without disrupting operation of gas turbomachine engine 10.

ARES module 58 receives input operating parameters 48 such as, without limitation, ambient pressure and temperature, compressor inlet guide vane position, fuel flow, inlet bleed heat flow, generator power losses, inlet and exhaust duct pressure losses, and/or compressor inlet temperature. ARES module 58 then generates estimated operating parameters 60, such as, without limitation, exhaust gas temperature 62, compressor discharge pressure, and/or compressor discharge temperature. In various embodiments, ARES module 58 uses estimated operating parameters 60 in combination with input operating parameters 48 as inputs to the gas turbomachine model to generate outputs, such as, for example, a calculated firing temperature 64.

In various embodiments, control system 18 receives as an input, a calculated firing temperature 52. Control system 18 uses a comparator 70 to compare calculated firing temperature 52 to nominal firing temperature 50 to generate a correction factor 54. Correction factor 54 is used to adjust nominal firing temperature 50 in MBC module 56 to generate a corrected firing temperature 66. Control system 18 uses a comparator 74 to compare the control outputs from ARES module 58 and the control outputs from MBC module 56 to generate a difference value. This difference value is then input into a Kalman filter gain matrix (not shown) to generate normalized correction factors that are supplied to control system 18 for use in continually tuning the control model of ARES module 58 thus facilitating enhanced control of gas turbomachine engine 10. In an alternative embodiment, control system 18 receives as an input exhaust temperature correction factor 68. Exhaust temperature correction factor 68 may be used to adjust exhaust temperature 62 in ARES module 58.

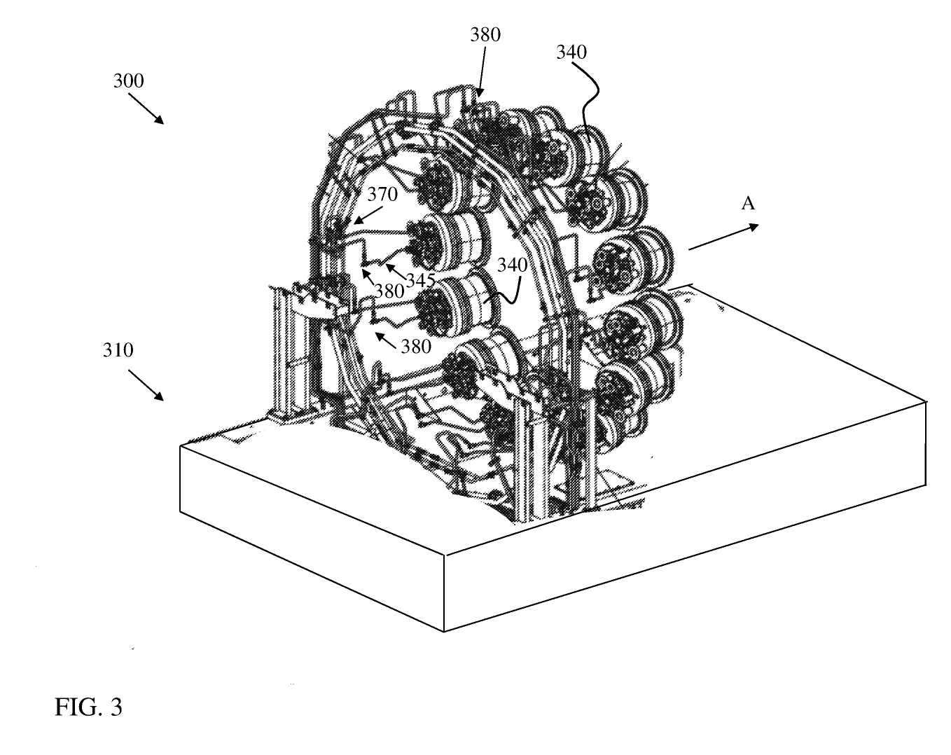

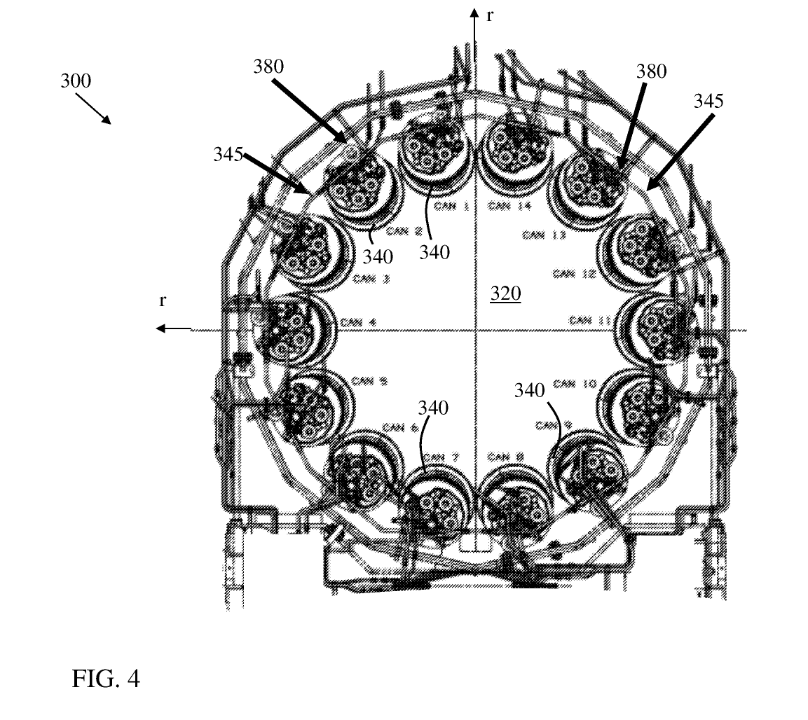

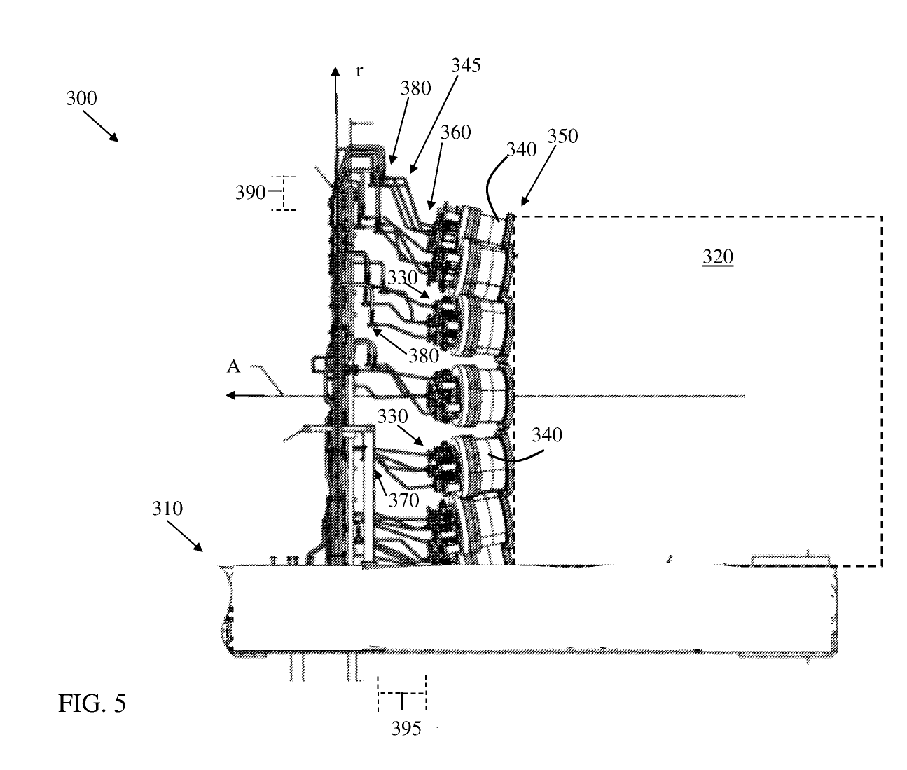

FIGS. 3-5 illustrate schematic views of a gas turbomachine fuel system 300 within combustor 14 (FIG. 1), which can be controlled by a computing device such as fuel control system 28 (e.g., via actuators such as actuator 27). FIG. 3 shows a schematic perspective view of fuel system 300, including a platform 310 upon which the fuel system 300 is mounted. FIG. 4 shows a schematic end view of the fuel system 300 and platform 310, and FIG. 5 shows a schematic side view of a portion of the fuel system 300, which is partially obstructed by platform 310. Fuel system 300 is shown coupled with a GT combustor wrapper (casing) 320 (shown in phantom in FIGS. 4 and 5), and is configured to combust fuel and generate a working fluid, i.e., gas, to drive turbomachine 16 (FIG. 1).

According to various embodiments, GT area of the fuel system 300 can include a set of fuel nozzles 330 disposed around combustor wrapper 320. In particular cases, fuel nozzles 330 are located adjacent combustor wrapper 320, and are each coupled with a combustion can 340 at an axial end 350 of combustor wrapper 320. Combustion cans 340 are circumferentially disposed around the combustor section of the GT, and can include an igniter for igniting the fuel as it flows from fuel nozzles 330 into combustion components contained within combustor wrapper 320, e.g., the flow sleeve, combustion liner and transition piece corresponding with each combustion can 340. The sets of fuel nozzles 330 and each of the corresponding cans 340 are disposed along a substantially circular path surrounding the central axis (A) of the combustor wrapper 320. Fuel nozzles 330 can include any conventional fuel nozzle for injecting a fuel, e.g., a primary (or, gas) fuel such as a natural gas, liquefied natural gas (LNG) or liquefied petroleum gas (LPG), and/or a secondary (or, liquid) fuel such as No. 2 diesel, kerosene or ethanol into combustion cans 340, in order to ignite that fuel and inject the ignited fuel into combustor wrapper 320.

Coupled with each of nozzles 330 is a corresponding conduit 345 (in a set of conduits 345), at a first end 360 of conduit 345. Conduit 345 can include a fuel line formed of a conventional fuel line material (e.g., a metal or composite plastic material) designed to store and transport GT fuel. In some cases, conduit 345 is referred to as stagnate fuel supply tubing. In some cases, coupled with a second end 370 of each conduit 345 is a liquid fuel check valve 380, which is radially offset (direction r) and axially offset (direction A) from its corresponding fuel nozzle 330 (e.g., in such a manner as to achieve separation of the conduits from the natural heat that is generated from the GT in order to minimize the coking effect). As described herein, the radial offset and axial offset between liquid fuel check valve 380 and its corresponding fuel nozzle 330 can separate the stagnate fuel from the natural heat of the GT during normal operations, e.g., to reduce and/or prevent fuel change-of-state from occurring. This configuration can increase GT alternate fuel reliability, e.g., due to reduced and/or eliminated alternate fuel system contamination (where fuel has changed state from liquid to hard carbon particles).

Liquid fuel check valves 380 can include any conventional mechanically controlled, electrically controlled or electro-mechanically controlled one-way valve for retaining liquid fuel and controlling release of that liquid fuel to fuel nozzles 330, e.g., based upon particular operating parameters. The check valves 380 are designed to halt fuel flow at low pressures and allow fuel flow at the high normal system operating pressures; which prevents fuel entering the fuel nozzles 330 at undesirable times. Check valves 380 are conventionally located as close to the fuel nozzles 330 as possible in order to minimize tubing fill time and to maintain the fuel system in a charged and ready state to operate on backup fuel quickly in the event of a primary fuel system loss of function or gas fuel loss. According to various embodiments, stagnate liquid fuel supply tubing (conduit 345) and the check valves 380 are circumferentially disposed around the combustor wrapper 320. In particular cases, as noted herein, stagnate liquid fuel supply tubing (conduit 345) and check valves 380 are located at a greater radial distance (direction r) from combustor wrapper 320 than set of fuel nozzles 330, such that stagnate liquid fuel supply tubing (conduit 345) and check valves 380 are maintained in a lower ambient temperature environment than the fuel nozzles 330, which sit adjacent to and mount directly to combustion can 340. In some cases, stagnate supply tubing (conduit 345) and (liquid fuel) check valves 380 are also axially separated (in direction A) from fuel nozzles 330, such that conduits 345 span an axial-radial path between fuel nozzles 330 and liquid fuel check valves 380. In some embodiments, the dynamic liquid fuel supply tubing spanning between the check valves and the fuel nozzles does not have a heat restriction, and will either be flowing purge air or liquid fuel at all times during operation (and thus avoid being stagnate).

In some particular embodiments, a radial offset 390 (FIG. 5) between (liquid fuel) check valves 380 and fuel nozzles 330 is equal to approximately (+/−1-3%) 1-2 meters (m). At a distance of approximately 0.5 m-1 m or greater, the temperature difference between liquid fuel tubing and check valves 380 and fuel nozzles 330 (as measured at an outer surface of these components) is lower than the liquid fuel change of state temperature during normal gas fuel operations when the liquid fuel is stagnate on standby status in the conduit 345. Additionally, as shown in FIG. 5, an axial offset 395 between check valves 380 and fuel nozzles 330 can be equal to approximately 2 m to 3 m, or a distance greater than the radial offset 390.

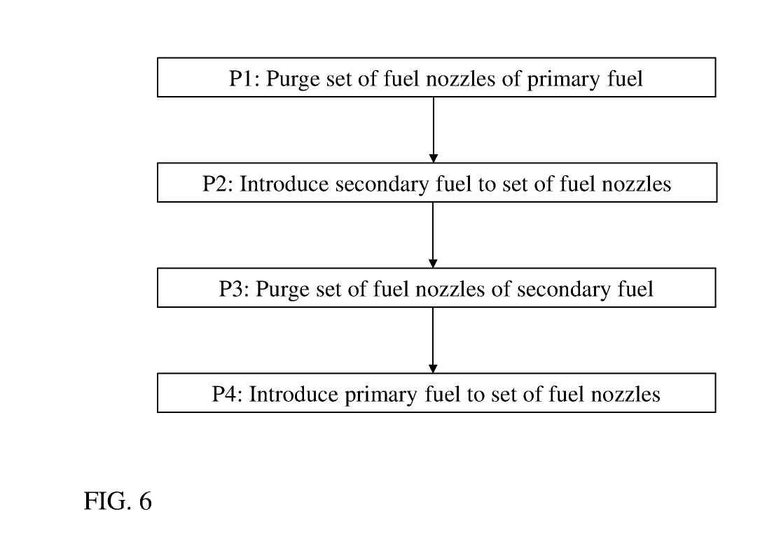

FIG. 6 shows a flow diagram illustrating a process in controlling gas turbomachine fuel system 300 within combustor 14 (FIG. 1), which can be controlled by a computing device such as fuel control system 28 (e.g., via actuators such as actuator 27). FIG. 7 shows an illustrative environment 102 demonstrating the fuel control system 28 coupled with GT 10 (FIG. 1) via at least one computing device 114. With reference to FIGS. 6 and 7, a control method can be performed (e.g., executed) using at least one computing device 114, implemented as a computer program product (e.g., a non-transitory computer program product) as a fuel control system 28, or otherwise include the following processes:

Process P1: purge the set of fuel nozzles 330 of the primary fuel (e.g., gas fuel) in response to receiving (or otherwise obtaining) operating parameter data (operating parameter 48, FIG. 2, FIG. 7) indicating a secondary fuel test is due. In some cases, operating parameter(s) 48 can indicate an issue with the primary fuel system, such that a firing temperature, output, flow rate, etc. deviate from corresponding threshold(s) that may suggest running on secondary fuel for a period would be advantageous. In other cases, operating parameter(s) 48 can indicate that a time since the last secondary fuel test has exceeded or is approaching a prescribed threshold, and that the secondary fuel should be introduced to purge the system and test the quality of that secondary fuel. Operating parameters 48 can be periodically or continuously monitored, e.g., via sensors 26, and/or may be modeled or otherwise logged using MBC module 56 and/or ARES module 58. Operating parameter(s) 48 can be stored locally or in a remote storage location, transmitted to fuel control system 28 or otherwise obtained (e.g., periodically or in response to a particular trigger) by fuel control system 28. In various embodiments, when a secondary fuel test is due, a cleaning fluid is introduced to fuel nozzles 330 to purge those fuel nozzles 330 of primary fuel.

Process P2 (after purging fuel nozzles 330 of primary fuel): introduce the secondary fuel to set of nozzles 330. In various embodiments, this can include providing operating instructions to liquid fuel check valves 380, or otherwise actuating liquid fuel check valves 380, to release the secondary fuel and permit flow of that secondary fuel through conduits 345 to fuel nozzles 330. In various embodiments, this can also include operating combustion cans 340 using secondary fuel to either test operation of the secondary fuel system or provide a period in which the primary fuel system can be repaired or otherwise inspected. Additionally, in various embodiments, fuel control system 28 (and/or control system 18) is configured to measure a fuel parameter (e.g., operating parameter 48) of the secondary fuel, using the sensor system (e.g., sensor(s) 26), after introducing the secondary fuel to set of nozzles 330. This measured fuel parameter can include pressure, flow rate, or other parameters affecting the combustion process. The combustion process measurement parameters can include the total temperature of each combustion can, the average temperature of a plurality of combustion cans, individual can temperatures, or the temperature differential between combustion cans. High temperature differential (either hot or cold) can be an indication if an improperly fired can most, e.g., due to artificially reduced or increased fuel flows, which may indicate the health of the primary and secondary fuel and/or fuel system(s) 300.

Process P3: purge set of fuel nozzles 330 of the secondary fuel after introducing the secondary fuel to set of fuel nozzles 330. Similarly to process P1, this can include introducing a similar or distinct cleaning fluid to fuel nozzles 330 to purge those fuel nozzles 330 of the secondary fuel.

Process P4: introduce the primary fuel to set of fuel nozzles 330 after purging the secondary fuel. This process can include providing operating instructions to fuel check valves 380, or otherwise actuating fuel check valves, to release the primary fuel and permit flow of that secondary fuel through conduits 345 to fuel nozzles 330.

As described herein and shown in FIG. 7, control system 18 (including fuel control system 28) can include any conventional control system components used in controlling a gas turbomachine engine (GT). For example, the control system 18 can include electrical and/or electro-mechanical components for actuating one or more components in the GT(s) 10. Control system 18 can include conventional computerized sub-components such as a processor, memory, input/output, bus, etc. Control system 18 can be configured (e.g., programmed) to perform functions based upon operating conditions from an external source (e.g., at least one computing device 114), and/or may include pre-programmed (encoded) instructions based upon parameters of the GT(s) 10.

As noted herein, system 102 can also include at least one computing device 114 connected (e.g., hard-wired and/or wirelessly) with control system 18, fuel control system 28, and GT(s) 10. In various embodiments, computing device 114 is operably connected with the GT(s) 10, e.g., via a plurality of conventional sensors such as flow meters, temperature sensors, etc., as described herein. Computing device 114 can be communicatively connected with the control system 18, e.g., via conventional hard-wired and/or wireless means. The control system 18 is configured to monitor the GT(s) 10 during operation according to various embodiments.

Further, computing device 114 is shown in communication with a user 136. A user 136 may be, for example, a programmer or operator. Interactions between these components and computing device 114 are discussed elsewhere in this application.

As noted herein, one or more of the processes described herein can be performed, e.g., by at least one computing device, such as computing device 114, as described herein. In other cases, one or more of these processes can be performed according to a computer-implemented method. In still other embodiments, one or more of these processes can be performed by executing computer program code (e.g., control system 18) on at least one computing device (e.g., computing device 114), causing the at least one computing device to perform a process, e.g., monitoring and/or testing a fuel system 300 in at least one GT 10 according to approaches described herein (FIG. 3).

In further detail, computing device 114 is shown including a processing component 122 (e.g., one or more processors), a storage component 124 (e.g., a storage hierarchy), an input/output (I/O) component 126 (e.g., one or more I/O interfaces and/or devices), and a communications pathway 128. In one embodiment, processing component 122 executes program code, such as control system 18, which is at least partially embodied in storage component 124. While executing program code, processing component 122 can process data, which can result in reading and/or writing the data to/from storage component 124 and/or I/O component 126 for further processing. Pathway 128 provides a communications link between each of the components in computing device 114. I/O component 126 can comprise one or more human I/O devices or storage devices, which enable user 136 to interact with computing device 114 and/or one or more communications devices to enable user 136 and/or CS 138 to communicate with computing device 114 using any type of communications link. To this extent, control system 18 can manage a set of interfaces (e.g., graphical user interface(s), application program interface, and/or the like) that enable human and/or system interaction with control system 18.

In any event, computing device 114 can comprise one or more general purpose computing articles of manufacture (e.g., computing devices) capable of executing program code installed thereon. As used herein, it is understood that “program code” means any collection of instructions, in any language, code or notation, that cause a computing device having an information processing capability to perform a particular function either directly or after any combination of the following: (a) conversion to another language, code or notation; (b) reproduction in a different material form; and/or (c) decompression. To this extent, control system 18 (and fuel control system 28) can be embodied as any combination of system software and/or application software. In any event, the technical effect of computing device 114 is to tune at least one GT 10 according to various embodiments herein.

Further, control system 18 (and fuel control system 28) can be implemented using a set of modules 132. In this case, a module 132 can enable computing device 114 to perform a set of tasks used by control system 18, and can be separately developed and/or implemented apart from other portions of control system 18. Control system 18 may include modules 132 which comprise a specific use machine/hardware and/or software. Regardless, it is understood that two or more modules, and/or systems may share some/all of their respective hardware and/or software. Further, it is understood that some of the functionality discussed herein may not be implemented or additional functionality may be included as part of computing device 114.

When computing device 114 comprises multiple computing devices, each computing device may have only a portion of control system 18 (and/or fuel control system 28) embodied thereon (e.g., one or more modules 132). However, it is understood that computing device 114 and control system 18 are only representative of various possible equivalent computer systems that may perform a process described herein. To this extent, in other embodiments, the functionality provided by computing device 114 and control system 18 can be at least partially implemented by one or more computing devices that include any combination of general and/or specific purpose hardware with or without program code. In each embodiment, the hardware and program code, if included, can be created using standard engineering and programming techniques, respectively.

Regardless, when computing device 114 includes multiple computing devices, the computing devices can communicate over any type of communications link. Further, while performing a process described herein, computing device 114 can communicate with one or more other computer systems using any type of communications link. In either case, the communications link can comprise any combination of various types of wired and/or wireless links; comprise any combination of one or more types of networks; and/or utilize any combination of various types of transmission techniques and protocols.

As discussed herein, control system 18 (and fuel control system 28) enables computing device 114 to control and/or monitor the fuel system 300 of at least one GT 10. Control system 18 may include logic for performing one or more actions described herein. In one embodiment, control system 18 may include logic to perform the above-stated functions. Structurally, the logic may take any of a variety of forms such as a field programmable gate array (FPGA), a microprocessor, a digital signal processor, an application specific integrated circuit (ASIC) or any other specific use machine structure capable of carrying out the functions described herein. Logic may take any of a variety of forms, such as software and/or hardware. However, for illustrative purposes, control system 18 (and fuel control system 28) and logic included therein will be described herein as a specific use machine. As will be understood from the description, while logic is illustrated as including each of the above-stated functions, not all of the functions are necessary according to the teachings of the invention as recited in the appended claims.

In various embodiments, control system 18 may be configured to monitor operating parameters of one or more GT(s) 10 as described herein. Additionally, control system 18 is configured to control fuel system 300 (FIGS. 3-5) according to various functions described herein.

It is understood that in the flow diagram shown and described herein, other processes may be performed while not being shown, and the order of processes can be rearranged according to various embodiments. Additionally, intermediate processes may be performed between one or more described processes. The flow of processes shown and described herein is not to be construed as limiting of the various embodiments.

In any case, the technical effect of the various embodiments of the disclosure, including, e.g., the control system 18 and fuel control system 28, is to control and/or monitor the fuel system 300 one or more GT(s) 10 as described herein.

In various embodiments, components described as being “coupled” to one another can be joined along one or more interfaces. In some embodiments, these interfaces can include junctions between distinct components, and in other cases, these interfaces can include a solidly and/or integrally formed interconnection. That is, in some cases, components that are “coupled” to one another can be simultaneously formed to define a single continuous member. However, in other embodiments, these coupled components can be formed as separate members and be subsequently joined through known processes (e.g., fastening, ultrasonic welding, bonding).

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A gas turbomachine fuel system comprising:
a plurality of combustion chambers circumferentially disposed around a gas turbine;
a set of fuel nozzles directly mounted to each of the plurality of combustion chambers;
a set of conduits coupled with each of the set of fuel nozzles at a first end of each of the conduits; and
a set of liquid fuel check valves coupled with a second end of each of the set of conduits, the set of liquid fuel check valves being positioned radially offset and axially offset from the set of fuel nozzles.

2. The gas turbomachine fuel system of claim 1, wherein the set of liquid fuel check valves are circumferentially disposed around the gas turbine.

3. The gas turbomachine fuel system of claim 1, wherein the set of fuel nozzles are located adjacent each of the plurality of combustion chambers.

4. The gas turbomachine fuel system of claim 3, wherein the set of liquid fuel check valves are located at a greater axial distance and a greater radial distance from each combustion chamber than the set of fuel nozzles.

5. The gas turbomachine fuel system of claim 1, wherein the set of conduits spans an axial-radial path between the set of fuel nozzles and the set of liquid fuel check valves.

6. The gas turbomachine fuel system of claim 1, wherein a distance of the radial offset between the set of liquid fuel check valves and the set of fuel nozzles is equal to approximately 1-2 meters.

7. The gas turbomachine fuel system of claim 1, wherein a distance of the axial offset between the set of liquid fuel check valves and the set of fuel nozzles is equal to approximately 1-3 meters.

8. A system comprising:
at least one computing device configured to control a fuel system in a gas turbomachine (GT), the fuel system including a plurality of combustion chambers circumferentially disposed around the GT; a set of fuel nozzles directly mounted to each of the plurality of combustion chambers for introducing a fuel into each of the plurality of combustion chambers; and a set of check valves fluidly coupled with the set of fuel nozzles and radially and axially offset from the set of fuel nozzles, the fuel including a primary fuel and a secondary fuel, the at least one computing device configured to:
purge the set of fuel nozzles of the primary fuel in response to receiving operating parameter data indicating a secondary fuel test is due;
introduce the secondary fuel to the set of fuel nozzles after purging of the primary fuel;
purge the set of fuel nozzles of the secondary fuel after introducing the secondary fuel to the set of nozzles; and
introduce the primary fuel to the set of fuel nozzles after purging the secondary fuel.

9. The system of claim 8, further comprising a sensor system coupled with the fuel system for detecting an operating parameter corresponding with the operating parameter data and providing the operating parameter data to the at least one computing device.

10. The system of claim 9, wherein the at least one computing device is configured to measure a fuel parameter of the secondary fuel, using the sensor system, after introducing the secondary fuel to the set of nozzles.

11. The system of claim 8, wherein purging the set of fuel nozzles of the primary fuel includes introducing a cleaning fluid to the set of fuel nozzles.

12. The system of claim 8, wherein the fuel system further includes: a set of conduits coupled with each of the set of fuel nozzles at a first end of each of the conduits and the set of check valves at a second end of each of the set of conduits, wherein introducing the secondary fuel to the set of nozzles includes actuating the set of check valves to release the secondary fuel and permit flow of the secondary fuel through the set of conduits to the set of fuel nozzles.

13. A gas turbomachine (GT) comprising:
a compressor section;
a combustor section coupled with the compressor section, the combustor section including:
a plurality of combustion chambers;
a set of fuel nozzles directly coupled with each of the plurality of combustion chambers;
a set of conduits coupled with each of the set of fuel nozzles at a first end of each of the conduits; and
a set of liquid fuel check valves coupled with a second end of each of the set of conduits, the set of liquid fuel check valves being positioned radially offset and axially offset from the set of fuel nozzles; and
a turbomachine section coupled with the combustor section.

14. The GT of claim 13, wherein the set of liquid fuel check valves are circumferentially disposed around the combustion chamber.

15. The GT of claim 13, wherein the set of fuel nozzles are located adjacent each of the plurality of combustion chambers.

16. The GT of claim 15, wherein the set of liquid fuel check valves are located at a greater radial distance from each of the plurality of combustion chambers than the set of fuel nozzles.

17. The GT of claim 13, wherein the set of conduits spans an axial-radial path between the set of fuel nozzles and the set of liquid fuel check valves.

18. The GT of claim 13, wherein a distance of the radial offset between the set of liquid fuel check valves and the set of fuel nozzles is equal to approximately 1-2 meters.

19. The GT of claim 13, wherein a distance of the axial offset between the set of liquid fuel check valves and the set of fuel nozzles is equal to approximately 1-3 meters.
